(19) United States
(12) Patent Application Publication
(10) Pub. No.: US 2023/0334483 A1
(43) Pub. Date: Oct. 19, 2023

(54) POLICY ENGINE

(71) Applicant: STRIPE, INC., South San Francisco, CA (US)

(72) Inventors: Rishabh Jain, San Francisco, CA (US); Robert Ying, Mercer Island, WA (US); Jeremiah Clemenson, San Francisco, CA (US)

(21) Appl. No.: 17/723,190

(22) Filed: Apr. 18, 2022

(51) Int. Cl. G06Q 20/38; G06Q 40/00; G06Q 20/12

(52) U.S. Cl. CPC G06Q 20/389; G06Q 40/12; G06Q 20/12

(57) ABSTRACT

Methods and apparatuses for processing transactions involving money movements using a policy engine are disclosed. In some embodiments, the method is a method comprises: intercepting a plurality of transactions received via network communications, each transaction of the plurality of transactions specifying a money movement and having a book keeping system of a commerce platform as a destination; and for each intercepted transaction, performing a policy evaluation process that includes determining if a fund flow transformation rule applies to said each intercepted transaction based on attributes associated with said each intercepted transaction, modifying at least one intercepted transaction by changing the money movement according to the fund flow transformation rule in response to determining a fund flow transformation rule applies to the at least one intercepted transaction, and sending said each intercepted transaction, including the at least one intercepted transaction with a modified money movement, to the book keeping system of a commerce platform.

### FIELD

Embodiments of the present disclosure relate to the field of processing of electronic transactions involving money movements; more particularly, embodiments of the present disclosure relate to applying fund flow policy constraints to money movements associated with electronic transactions.

### BACKGROUND

Some merchants choose to minimize their investment by working with third parties to handle all their payment needs. These third parties are often referred to as payment processors. In these cases, the merchants redirect their customers to the third party, which is responsible for capturing the payment information and processing the transaction. The payment processor will later pay the merchants for successful transactions under previously agreed upon terms.

As part of paying merchants, the payment processors move money today on an application layer. These movements may comprise a number of different fund flows involving account balances of multiple parties. These fund flows may be between account balances of parties within control of the payment processor or from an account within control of the payment processor to an external account of another, or vice versa.

As the number of fund flows grows large, the money movements may become more complex. Further complicating the situation is that many fund flows are subject to external regulations (e.g., banking regulations). Merchants and other customers of the payment processor want the payment processor to build more and more fund flows and/or augment existing ones without thinking about the inter-workings of payment networks (e.g., the Global Payment and Treasury Network (GPTN)) and without worrying about external regulations.

### SUMMARY

Methods and apparatuses for processing transactions involving money movements using a policy engine are disclosed. In some embodiments, the method is a method comprises: intercepting a plurality of transactions received via network communications, each transaction of the plurality of transactions specifying a money movement and having a book keeping system of a commerce platform as a destination; and for each intercepted transaction, performing a policy evaluation process that includes determining if a fund flow transformation rule applies to said each intercepted transaction based on attributes associated with said each intercepted transaction, modifying at least one intercepted transaction by changing the money movement according to the fund flow transformation rule in response to determining a fund flow transformation rule applies to the at least one intercepted transaction, and sending said each intercepted transaction, including the at least one intercepted transaction with a modified money movement, to the book keeping system of a commerce platform.

### BRIEF DESCRIPTION OF THE DRAWINGS

The present disclosure will be understood more fully from the detailed description given below and from the accompanying drawings of various embodiments of the disclosure, which, however, should not be taken to limit the disclosure to the specific embodiments, but are for explanation and understanding only.

FIG. 1 is a block diagram of an example of a network environment with commerce platform.

FIG. 2 illustrates a portion of a commerce platform that processing money movement transactions as part of book keeping operations.

FIG. 3 illustrates some embodiments of a policy engine that performs a policy evaluation process on money movement transactions (e.g., money movement requests).

FIG. 4 illustrates one embodiment of a gating rule interface.

FIG. 5 illustrates one embodiment of a fund flow transformation interface.

FIG. 6 illustrates an example of a transformation rule splitting entries.

FIG. 7 illustrates one embodiment of an event analysis interface.

FIG. 8 illustrates one embodiment of propagation interfaces.

FIGS. 9 and 10 illustrate examples of tag propagation.

FIG. 11 illustrates one embodiment of a balance invariant resolution interface.

FIG. 12 is a flow diagram of one embodiment of a process for processing money movement transactions.

FIG. 13 is a block diagram of one embodiment of a computer system that may be used to support the systems and operations discussed herein.

### DETAILED DESCRIPTION

In the following description, numerous details are set forth to provide a more thorough explanation of the present disclosure. It will be apparent, however, to one skilled in the art, that the present disclosure may be practiced without these specific details. In other instances, well-known structures and devices are shown in block diagram form, rather than in detail, to avoid obscuring the present disclosure.

Techniques are disclosed herein for processing transactions in an ecommerce platform. In some embodiments, the transactions involve money movements and the techniques disclosed herein involve the use of a policy engine in the ecommerce platform that completes the transactions to a money movement platform, or the book keeping layer/system, of the ecommerce platform. In some embodiments, the policy engine receives all logical booking rights to the book keeping system. Such a book keeping system may be responsible for handling the net cash flow for the ecommerce platform. Note that for purposes herein, the book keeping system may include multiple computing systems, such as, for example, servers and/or personal computer systems.

In some embodiments, the policy engine processes transactions with money movements by performing fund flow transformations. These fund flow transformations may be used to change the flow of funds specified by the money movement. The change may be based on application of a policy by the policy engine. The application of the policy may involve applying a constraint, referred to herein as a system invariant, to the money movement with the fund flow transformations being implemented as rules. For example, if the policy indicates that a portion of a pay-in fund flow should be reserved (e.g., 10% of the money movement or fund flow) due to a risk associated with the transaction, the constraint may indicate that the portion of the fund flow, representing a risk reserve, should be made to a risk reserve balance as part of completing the transaction. In such a case, the policy engine transforms the money movement associated with the transaction to include a flow of funds into the risk reserve balance. In some embodiment, the transformation rules allow money movement from net credited balances of a customer (e.g., merchant) to their reserve balance. Other fund flow transformation rules, for example, allow the application of constraints to enable the use of pre-funding balances for use in covering items such as, for example, disputes and refunds. In such cases, the fund flow transformation rule can apply a constraint to pick the “pre funding” balance on such flows. As shown by these examples, in some embodiments, system invariants are encoded in policy through the use of fund flow transformations.

Other uses of fund flow transformation rules can specify which funds (e.g., balances) are used to fulfill a transaction. For example, in a country such as Brazil, a fund flow transformation rule can apply a policy to ensure that money is only moved through a Brazil-tagged balance. For example, when trying to satisfy a transaction through multiple tagged buckets of money, the policy engine may select one of a number of ways to complete the transaction. For example, if merchant M1 has account balances B1 and B2 that are used to move money to merchant M2, the policy engine may determine and cause the money movement to be completed using a series of linearized transfers or a set of parallelized split transfers. In the case of linearized transfers, the policy engine may specify the money movement as first moving M1[B2]→M1[B1] and then move M1[B1]→M2[B2]. In the case of parallelized splits, the policy engine may specify the money movement as moving M1[B1]→M2[B1] and M1[B2]→M2[B2] at the same time.

In some embodiments, the policy engine uses tagging and tag propagation as part of implementing a policy. The tag propagation may propagate a tag across money movement chains associated with transactions. The use and propagation of tags may help in the traceability of funds, which is particularly important for regulators of payment processing providers and banking-related operations.

An example of a commerce platform is described below. In some embodiments, the commerce platform may include payment processing through the use of a payment processor, such as, for example, STRIPE™. After describing an example of a commerce platform, embodiments of a policy engine and transaction processing will be described in more detail.

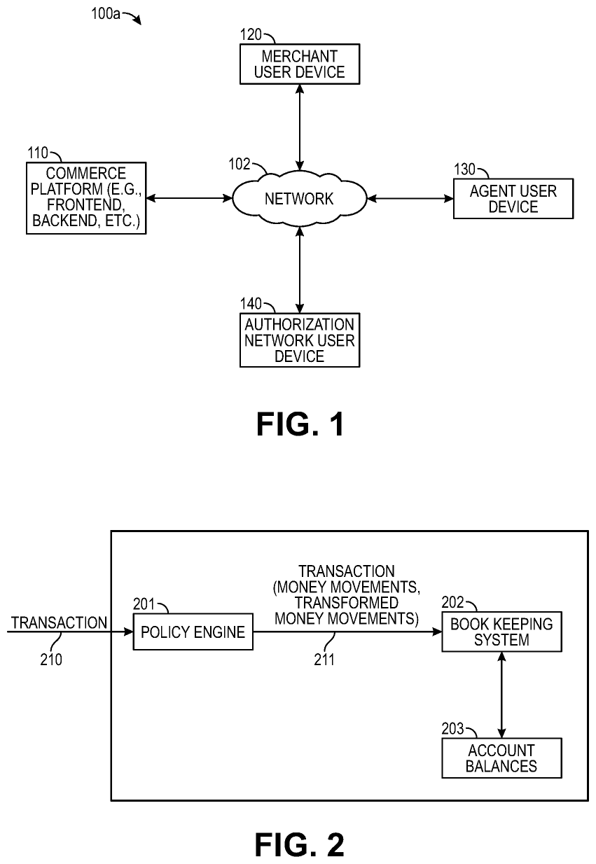

FIG. 1 is a block diagram of an example of a system 100 for a commerce platform. In one embodiment, system 100 includes a commerce platform 110, a merchant user device 120, an agent user device 130, and an authorization network user device 140. In one embodiment, user devices (e.g., devices 120, 130, and 140) may be mobile computing devices, such as a smartphone, tablet computer, smartwatch, etc., as well computer systems, such as a desktop computer system, laptop computer system, server computer systems, etc. The commerce platform 110 may also be one or more computing devices, such as one or more server computer systems, desktop computer systems, etc.

The commerce platform 110, merchant user device 120, agent user device 130, and authorization network user device 140 may be coupled to a network 102 and communicate with one another using any of the standard protocols for the exchange of information, including secure communication protocols. In one embodiment, one or more of the commerce platform 110, merchant user device 120, agent user device 130, and authorization network user device 140 may run on one Local Area Network (LAN) and may be incorporated into the same physical or logical system, or different physical or logical systems. Alternatively, the commerce platform 110, merchant user device 120, agent user device 130, and authorization network user device 140 may reside on different LANs, wide area networks, cellular telephone networks, etc. that may be coupled together via the Internet but separated by firewalls, routers, and/or other network devices. In one embodiment, commerce platform 110 may reside on a single server, or be distributed among different servers, coupled to other devices via a public network (e.g., the Internet) or a private network (e.g., LAN). It should be noted that various other network configurations can be used including, for example, hosted configurations, distributed configurations, centralized configurations, etc. In one embodiment, commerce platform 110 provides software service, e.g., financial processing services to one or more of merchant user device 120, agent user device 130, and/or authorization network user device 140, such as managing accounts, running financial transactions, clearing transactions, performing payouts to agents, managing merchant and/or agent accounts, as well as other services typically associated with commerce platforms systems such as, for example, STRIPE™.

In some embodiments, the commerce platform includes a book keeping system or a booking layer that records financial transactions (e.g., payment processing transactions). In some embodiments, these transactions include money movements between accounts (e.g., between account balances) or involve at least one account (e.g., a payout, a payment, etc.) of or controlled by a payment processor. In some embodiments, the account balances may be those of customers (e.g., merchants, users, banks, etc.) of the payment processing system, and transactions are designated or otherwise addressed to the book keeping system. In some embodiments, these transactions are sent as network communications or messages to the book keeping system over one or more network connections.

### Policy Engine Architecture

FIG. 2 illustrates a portion of a commerce platform that processes money movement transactions as part of book keeping operations. Referring to FIG. 2, commerce platform 200 includes a policy engine 201 that receives transactions 210 that involve money movements that are to occur at the book keeping system 202. Policy engine 201 enforces policies with respect to those money movements. In some embodiments, the enforcement of policies may involve mutating or changing a money movement specified in a transaction into one or more money movements that adhere to or are in line with a policy being enforced or implemented.

In some embodiments, policy engine 201 intercepts transactions and converts them to a materialized transaction for a fund flow. To that end, policy engine 201 acts as a centralized place to apply a materialized set of instructions based on policy constraints to a fund flow. In some embodiments, policy engine 201 performs this function by mapping a transaction to the set of rules that should apply, internally (e.g., system/GPTN specific rules) and/or globally (e.g., regulatory), and cross verifies if the proposed set of instructions are valid. In the case the instructions are not valid, in some embodiments, policy engine 201 tries to materialize a reasonable alternative that will satisfy both the rules and what the transaction was originally intended to do at creation.

After policy engine 201 has completed performing policy enforcement, transactions 211 are forwarded onto book keeping system 202 for completion. Note that transactions 211 may include some transactions that have money movements that were not changed by policy engine 201, while other transactions have money movements that were changed by policy engine 201.

After receiving transactions 211, book keeping system 202 uses one or more of account balances 203 to complete the transactions. Account balances 203 may include balances of customers (e.g., merchants) of a payment processor and these may include payment balances, risk reserve balances, expense payment balance, or other balances that a handler of money movements (e.g., a payment processor) may use.

In some embodiments, policy engine 201 comprises a compiling and tagging system that provides an interface to do legal money movements. In such a case, policy engine 201 receives and converts each transaction into materialized transaction for a fund flow while tagging and persisting tags into the book keeping system that are part of book keeping rights. These transactions trigger actual cash flow off these book keeping rights.

In some embodiments, policy engine 201 intercepts all book keeping rights transactions and determines which policy rules to apply to each transaction, if any. In some embodiments, this determination is made by inspecting a set of attributes to determine if a policy rule applies. These attributes can relate risk rules that apply to a merchant or other customer associated with the transaction, a purpose of money movement (top off an account, top off for future refund or dispute, transfer between two accounts of payment processor, etc.), an amount of the transaction, etc.).

If policy engine 201 determines that a policy rule applies, policy engine 201 uses transformation rules to modify, or otherwise mutate, book keeping rights based on system invariants that are encoded in policy through fund flow transformations. As such policy engine 201 applies constraints to a fraction of the fund flows associated with a transaction. In some embodiments, the constraints apply to merchants (or other customers) linked within a transaction, to how money should move for a GPTN fund flow, and/or to the account balances that are linked within a transaction. In other words, policy engine 201 performs modifications to the money movements of the transactions to enable the transaction to adhere to the policies that are applied to the transactions. For example, policy engine 201 can use one or more transformation rules to mutate a transaction by splitting a single money movement into multiple segmented money movements. Other mutations may include adding one or more different accounts (e.g., account balances) to the fund flow to implement the money movement. Such transformation rules can allow the movement of money from net credited balances of a merchant to another balance (e.g., a reserve balance to deal with risk reserve on pay-ins).

After applying the policies to the money movements of the transactions via any necessary modifications, policy engine 201 performs writes to send the transactions (e.g., mutated transactions) to book keeping system 202 with instructions that specify to book keeping system 202 as to the manner in which each transaction is to be fulfilled. In some embodiments, there instructions include all the account balances (e.g., regular balance, risk reserve balance, etc.) that are to be used to fulfil each transaction and/or the order in which they are applied.

In some embodiments, policy engine 201 can also assign or add a tag to each transaction. In some embodiments, the tag comprises a qualitative representation of a balance. The tag applies a context to the money as it moves through the book keeping system. This is particularly useful where policy engine 201 applies fund flow transformation rules to modify a transaction to be fulfilled with segmented into different account balances with each segment being tagged with a certain amount of the money movement. In some embodiment, policy engine 201 propagates the tags across the money movement including the source and destination account balances. In some embodiments, policy engine 201 propagates the tag to book keeping system 202 where the tag is persisted. In some embodiments, each tag comprises a key:value pair that is stored in a database.

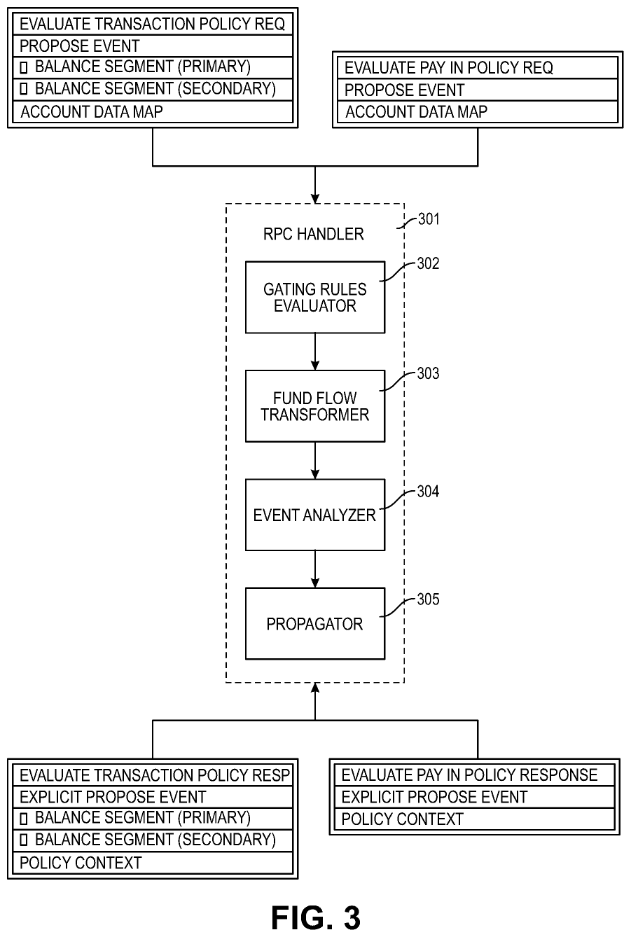

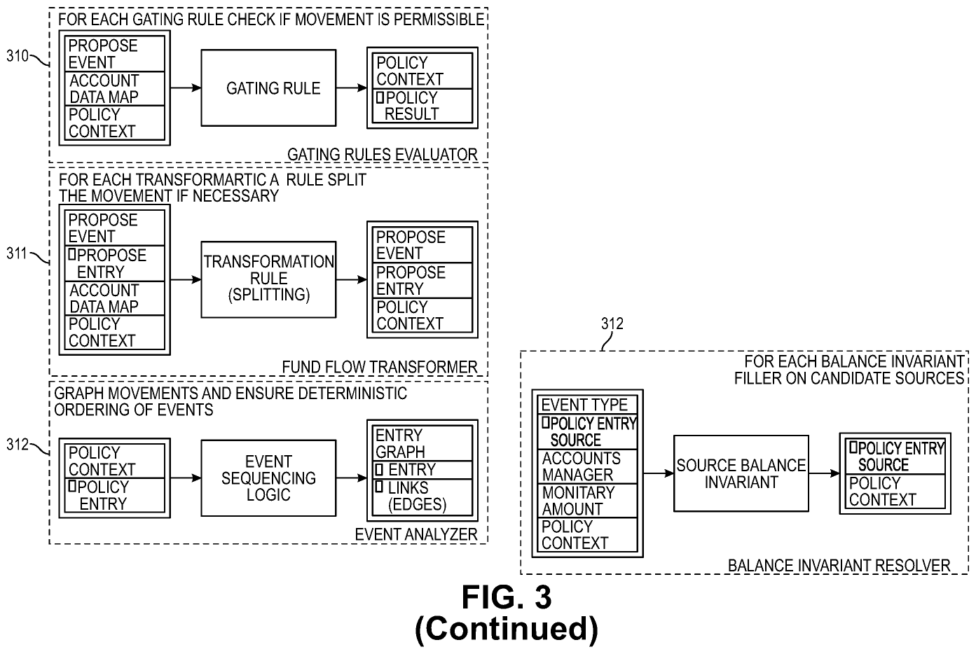

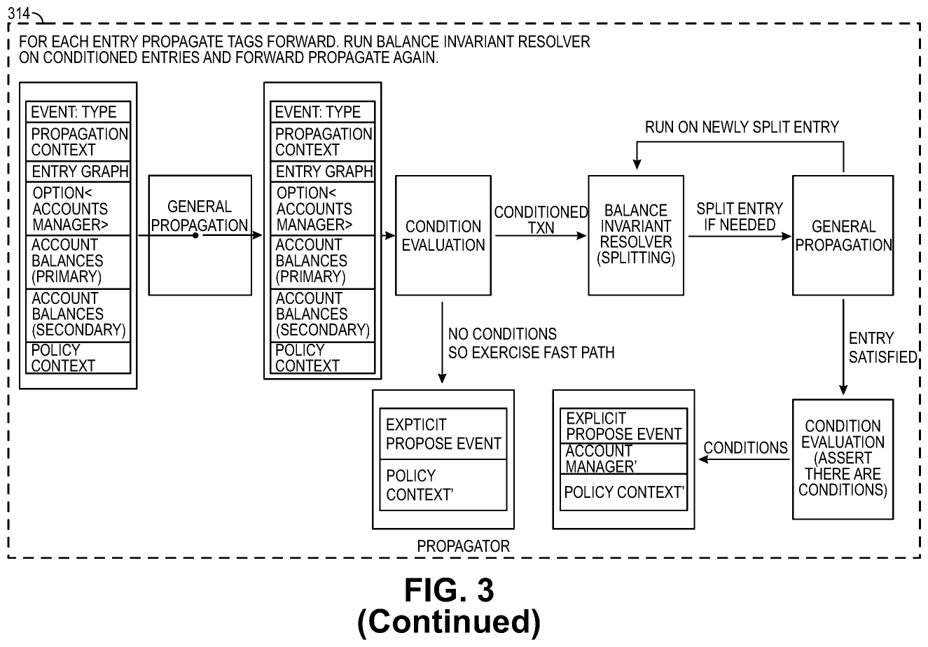

FIG. 3 illustrates some embodiments of a policy engine that performs a policy evaluation process on money movement transactions (e.g., money movement requests). In some embodiments, the policy engine is implemented, at least in part, by processing logic comprising hardware (e.g., circuitry, dedicated logic, etc.), software (e.g., software running on a chip, software run on a general-purpose computer system or a dedicated machine, etc.), firmware, or a combination of the three.

Referring to FIG. 3, the policy engine includes an RPC handler 301 to handle the life cycle of a transaction. In some embodiments, each of these transactions comprises a request for money movement. RPC handler 301 takes validated requests in and drives the policy evaluation process performed by the policy engine. In some embodiments, RPC handler 301 includes a number of modules to process transactions including, but not limited to, a gating rule evaluator 302, a fund flow transformer 303, an event analyzer 304 and a propagator 305.

After RPC handler 301 receives each transaction, a gating rules evaluator 302 applies gating rules to each money movement request of the transaction. In some embodiments, the gating rules are hard pre-checks through which all fund flows go. Gating rules evaluator 302 can reject a transaction if the request of the money movement is not allowed by one or more gating rules. These determinations may be based on static data that can be found within the request. As an example, in some embodiments, gating rules evaluator 302 disallows transaction that involve a merchant in certain countries in which the payment processor doesn't operate. In some embodiment, when gating rules evaluator 302 rejects a transaction, gating rules evaluator 302 sends a failure indication or other message to the originator or predefined party indicating that the transaction has been rejected.

After the policy engine has performed the gating rules evaluation, a fund flow transformer 303 receives the transactions that passed the gating rules and determines whether one or more fund flow transformation rules apply to each transaction. The fund flow transformation rules impose constraints on the money movements that may be performed. In some embodiments, the policy engine supports the following classes of constraints: constraints that apply on merchants (customers) linked within a transaction, constraints that apply on how money should move for a GPTN fund flow and/or transaction, constraints that apply for the account balances that are linked within a transaction. Other constraints may be imposed by the policy engine.

If fund flow transformer 303 determines one or more fund flow transformation rules applies to a transaction, fund flow transformer 303 augments the transaction to dictate the way the fund flow for the request should occur. This augmentation process may include transforming, or mutating, a transaction based on predefined rules in order to adhere to system invariants that specify a policy to be applied to such a transaction. The resulting transformation still results in the same number of transactions; however, there may be more than one money movement associated with a transaction after transformation. For example, fund flow transformer 303 can transform a money movement by splitting the money movement into multiple transfers (e.g., serialized transfers, parallel transfers, etc.).

Note that if fund flow transformer 303 determines that no fund flow transformation rules apply to a transaction, fund flow transformer 303 leaves the transaction unchanged.

After fund flow transformer 303 has finished with each transaction, an event analyzer 304 computes a list of proposed entries to complete the money movements associated with the transaction (whether transformed or not). In some embodiments, the proposed entries includes an order list of money transfers that include correct source and destinations accounts (e.g., account balances, account numbers, etc.).

In some embodiments, event analyzer 304 transforms the money movement of a transaction into a graph representation of a proposed money movement that models ordered money movements in the transaction. In some embodiments, each graph includes a deterministic way to be traversed. In some embodiments, event analyzer 304 analyzes the graph and transforms it. As part of analysis, event analyzer 304 can sort the graph using a modified topological sort that based on flow order in which the money transfers are to be performed. For example, the graph may be sorted so that the money transfers occur serially from largest to smallest. In some embodiments, the graph may be sorted from net debited to net credited ordering of funds flow. However, other orders may be used.

After transforming the graph, event analyzer 304 materializes the planning entries into a plan containing final proposed entries, updated balances, and policy results. This may be performed in multiple stages: funding and balance selection. During the funding stage, event analyzer 304 creates funding entries to complete the money movement. After the funding stage, event analyzer 304 performs a balance selection stage where the account balances for the funds for the money movement are selected. In some embodiments, event analyzer 304 performs balance selection by running all of the planning entries though a DFS.

After event analyzer 304 is finished operating on a transaction, propagator 305 propagate tags across the transfers associated with each transaction. For example, as discussed herein, balances are used to fulfill money movements and those balances may have different tags. These tags can be added by the funds flow transformer as part of the use of the transformation rules. Such tags are propagated by propagator 305. In some embodiments, propagator 305 propagates account tags across the entire money movement chain, including where entries are linked together (e.g., a destination account of one is equivalent to the source of the other).

In one embodiment, propagator 305 also performs condition evaluation with respect to balances chosen to fulfill a fund flow of a transaction. This condition evaluation can involve adding conditions on certain balances when returning a response to the transaction.

In some embodiments, propagator 305 includes a balance invariant resolver that runs balance invariants as applied constraints on the list of source balances in the transaction while taking into account current balances and proposes a list of source balances and limits on amounts that can be drawn from each source balance.

As shown in FIG. 3, each of the components of RPC handler 301 includes one or more interfaces. In some embodiments, gating rule evaluator 302 includes a gating rule evaluation interface 310, fund flow transformer 303 includes a fund flow transformation interface 311, event analyzer 304 includes an event analysis interface 312, and propagator 305 includes propagation interfaces 314. These will be described in more detail below.

### Phase 1: Gating Rule Evaluation

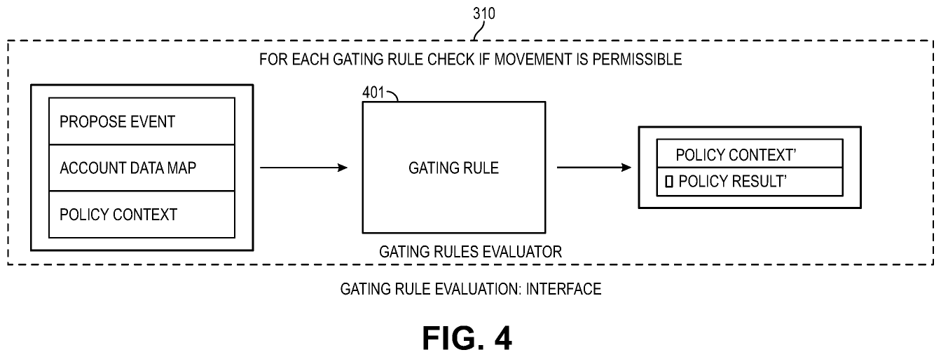

In some embodiments, gating rules are hard pre-checks that all fund flow should go through. In some embodiments, the gating rule evaluator 302 applies the gating rules to each transaction and the result of the application is an indication (e.g., a yes or no answer) as to whether or not a gating rule applies. If a gating rule does apply to the transaction, the policy engine is not going to augment the transaction and the transaction fails. In some embodiments, gating rules depend only on static data provided in the request. FIG. 4 illustrates one embodiment of a gating rule interface, such as, for example, gating rule interface 310 of FIG. 3.

Referring to FIG. 4, for each transaction (ProposeEvent), the gating rule evaluation applies a gating rule 401 that is checked. Examples of gating rule 401 include disallowing a transaction involving merchants (customers) in a country in which the payment processor using the policy engine doesn't operate (e.g., Iran) and only allowing a fund flow for certain transactions in a specific currency (e.g., manual payouts only work for US dollars). In some embodiments, if there is a failure at this step, the RPC handler returns a failure with the PolicyContext.

### Phase 2: Fund Flow Transformation

As mentioned above, the fund flow transformer augments a given transaction to abide by specific rules based on how a fund flow should operate. These rules may be specified by the payment processor or regulatory bodies. In some embodiments, the transformations are deterministic and don't depend on account balances but only on fund flow semantics.

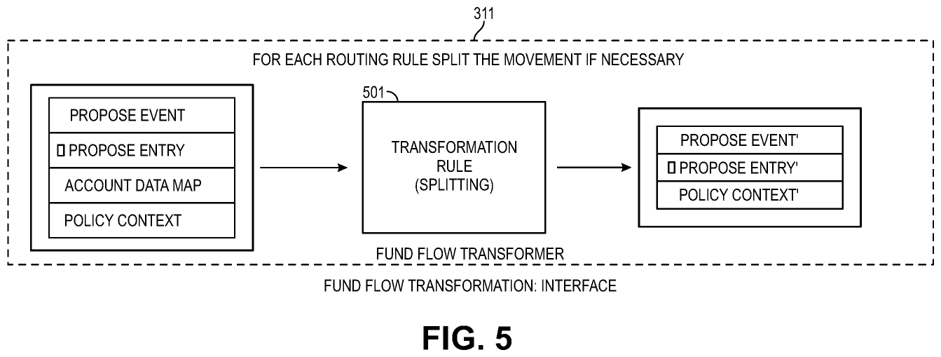

FIG. 5 illustrates one embodiment of a fund flow transformation interface, such as, for example, fund flow transformation interface 311 of FIG. 3. Referring to FIG. 5, the fund flow transformation interface includes transformation rules, such as, for example, transformation rule 501. In some embodiments, the transformations rules describe how a money movement should happen at the payment processor and usually contain system invariants that apply to all customer services provided by a payment processor.

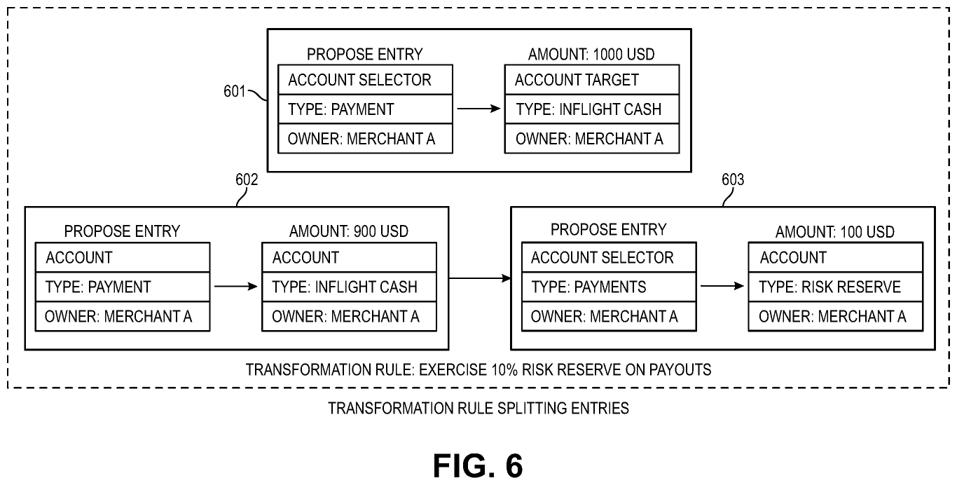

An example of a fund flow transformation rule is splitting a money movement into multiple transfers for completion by the book keeping system such as in the case of handling risk reserves by splitting the transaction into two parts, one of which goes to the risk reserve account of the merchant and the remainder to the payments balance (account). FIG. 6 illustrates an example of a transformation rule splitting entries. Referring to FIG. 6, transaction 601 includes a proposed money movement (ProposeEntry) that is a payout in the amount of $1000 USD to a merchant as a payment. The transformation rule is applicable to the transaction and calls for a 10% risk reverse on payout. In such a case, the transformation rule modifies the money movement of transaction 601 into two money movements (ProposeEntry) 602 and 603, in which the first money movement for $900 USD goes from one account (Payment) of the merchant (Merchant A) to another account (Inflight Cash) of the merchant (Merchant A) and the second money movement for $100 USD, equal to the 10% specified in the rule, goes from one account (Payment) of the merchant (Merchant A) to another account (Risk Reserve) of the merchant.

Another example of a fund flow transformation rule is that a regulated top-up value should be tagged as stored value.

### Phase 3: Event Analysis

As discussed above, the event analyzer pre-processes the transformed event and computes an ordered list of proposed entries to be written to the book keeping system where the money movement transaction is completed. In some embodiments, the event analyzer examines a transaction to ensure that there is only one net-debited source within a transaction and entry sequencing is deterministic.

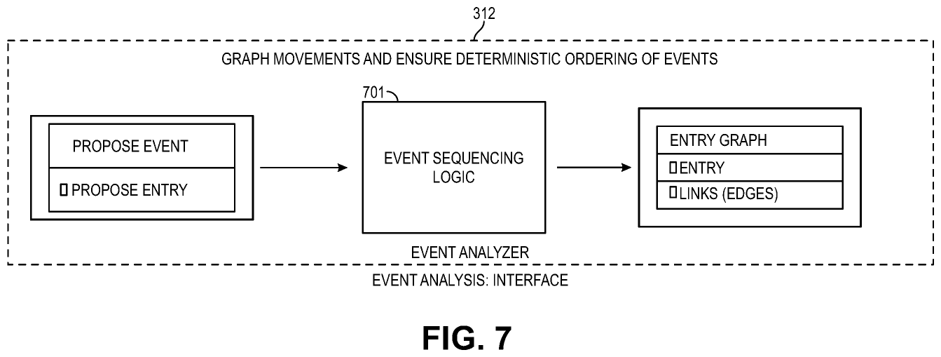

FIG. 7 illustrates one embodiment of an event analysis interface, such as, for example, event analysis interface 312 of FIG. 3. Referring to FIG. 7, the event analysis interface includes event sequencing logic 701 that receives a proposed money movement (ProposeEvent) and returns a graph (EntryGraph) that models ordered money movements in the transaction. In some embodiments, the graph has references to the entries, the links within those entries, and a deterministic way in which the graph is to be traversed.

### Phase 4: Propagation

The propagator performs the propagation phase of the transaction processing. The propagation phase involves finding conditions on the policy-transformed movement, propagating tags, and optionally running balance invariants.

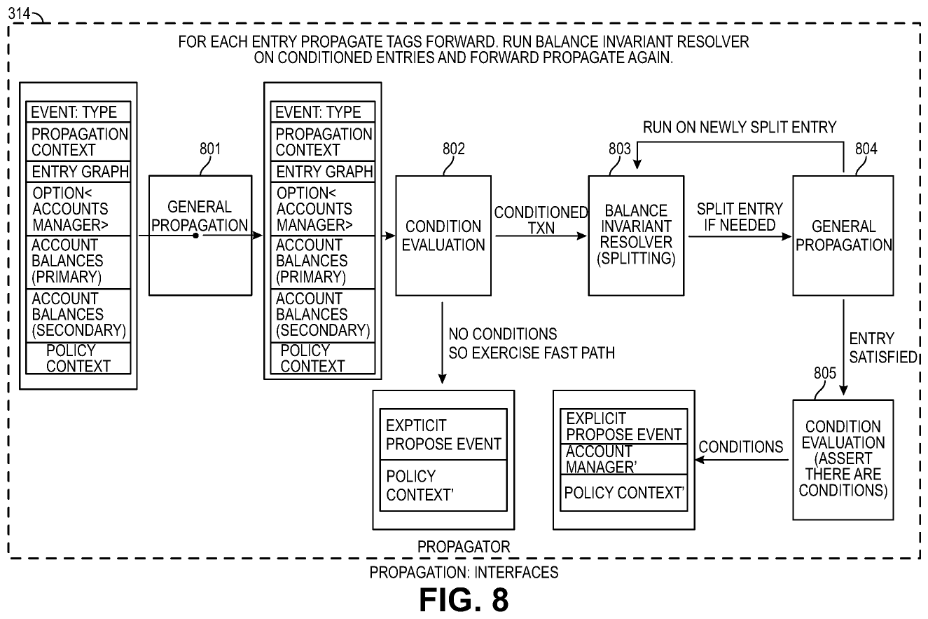

FIG. 8 illustrates one embodiment of propagation interfaces, such as, for example, propagation interface 314 of FIG. 3. Referring to FIG. 8, propagation interfaces includes a number of modules including general propagation module 801, condition evaluation module 802, balance invariant resolver module 803, general propagation module 804 and condition evaluation module 805. These modules are explained in more detail below. The references to PropagationContext in FIG. 8 refer to an entry to the propagation interfaces and is a wrapper around the entry graph from the event analyzer that helps with splitting the entries while maintaining order and propagating tags across the entry graph.

In some embodiments, modules of the propagation interfaces ensure that a number of system invariants are met for each money movement transaction. In some embodiments, these invariant include one or more of the following:
1) unconditioned accounts don't require account balances;
2) accounts with negative balances shouldn't be used as a net-debit source unless we are processing refunds;

3) tags are always propagated forward unless the entries explicitly specify otherwise;
4) entry splitting is performed on zero crossings when drawing from account balances to satisfy the movement amount; and
5) tag propagation is deterministic.

### Propagation Phase 1: General Propagation

General propagation within the policy engine refers to propagating the account tags across the entire money movement chain of a transaction. Given a money movement event may consists of multiple entries with source account balances and destination account balances, it is not uncommon for these entries to be linked together (e.g., destination of one entry is equivalent to the source of the other). In such scenarios, the propagator preserves the tags across the chain for the same type of accounts. This ensures that funds are not intermingled between different logical accounts.

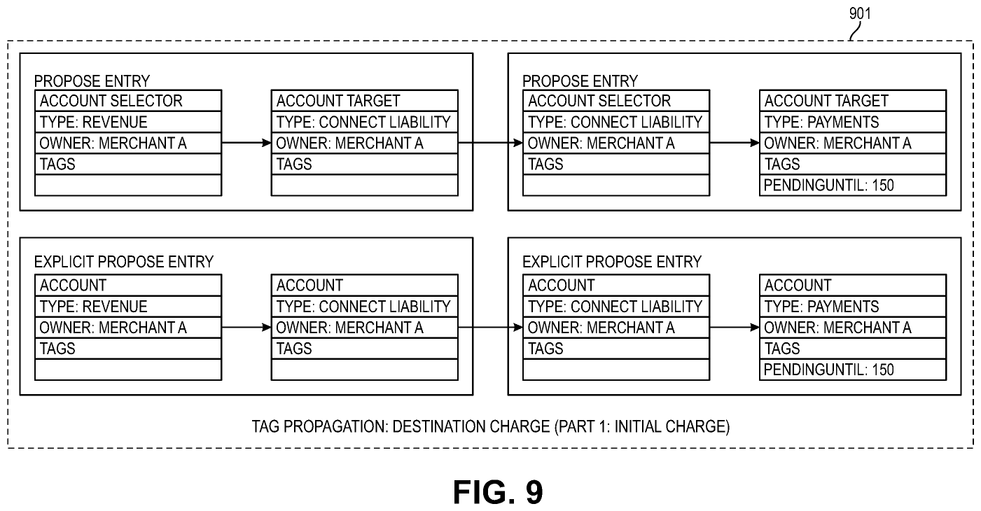

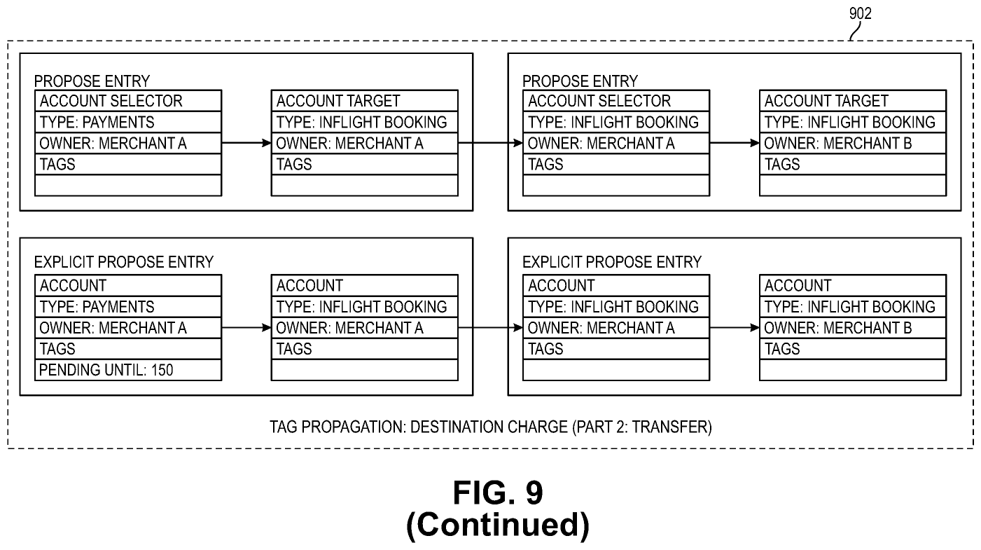

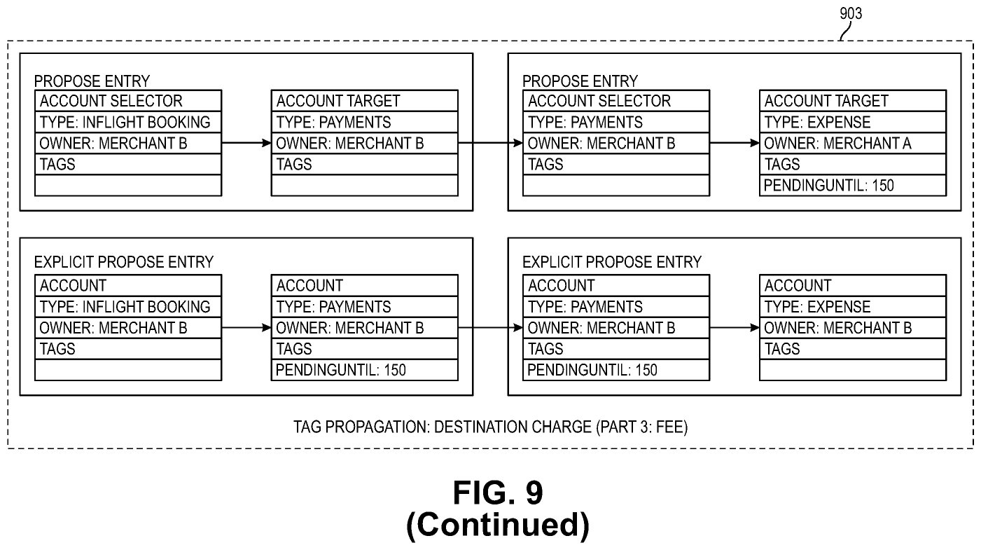

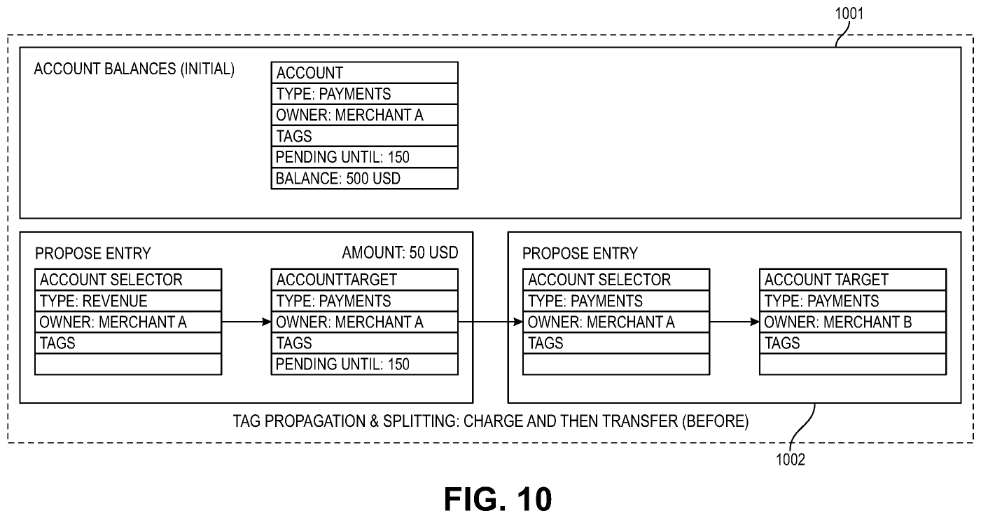

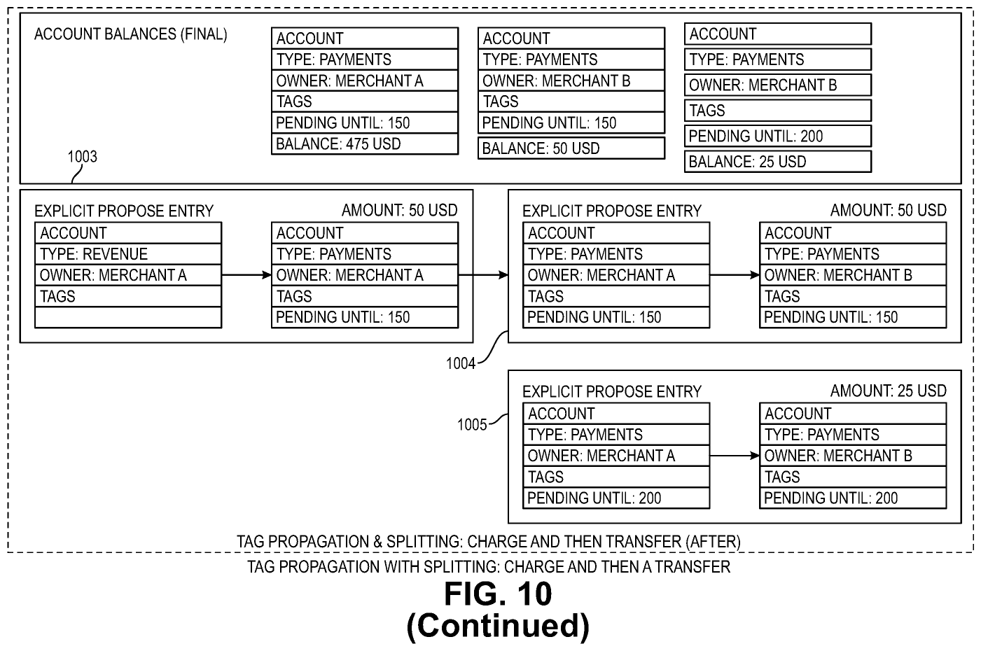

FIGS. 9 and 10 illustrate examples of tag propagation. FIG. 9 illustrates a case of tag propagation in the destination charge case. In this case, there is one event split across three parts 901-903, namely the initial charge, the transfer, and the fee. In part 901, the request specifies that the first part of the transaction, the initial charge, will come into the Payments account of A on a later time pending_until: 150. Assuming that Account A doesn't have any other available sub balances, this constraint has implications over the rest of the entries in the transaction as money movement at each step will be delayed. The policy engine handles such cases by propagating the tags to the relevant accounts. Notice that there is a tag propagated at every relevant Payments account in the chain: pending_until: 150

FIG. 10 illustrates that case of Tag Propagation with splitting in which there is a charge and then a transfer. Referring to FIG. 10, assume that Merchant A starts with an initial balance of $500 USD that is pending until a time 200 ms (1001). The money movement request specifies first doing a charge for $50 USD by Merchant A (1002), which is pending until a time 150 ms in future, and then doing a transfer of $75 USD from Merchant A to Merchant B (1002).

Subsequently, the final balances (1003) of the Payments account of Merchant A is $425 USD that is pending until a time 150 ms, Payments account of Merchant B is $50 USD that is pending until a time 150 ms, and Payments account of Merchant B is $25 USD that is pending until a time 200 ms. The

As shown above, in some embodiments, the policy engine splits transfer into two parallel transfers (1104 and 1005) where the first one will come from the funds created by the initial charge (as it has an earlier pending until expiry—this is a system invariant) and the second transfer will be funded by the other account balance for Merchant A (with a pending until of 200). The policy engine will take care of propagating the correct tags in both of the transactions.

### Propagation Phase 2: Condition Evaluation

In some embodiments, because the money movement transactions are operating on account balances and consistency must be maintained from the customer's point of view, the policy engine can optionally add conditions on certain balances when returning the response to the book keeping system to ensure consistency. These conditions are evaluated prior to resolving balance invariants.

Note that if there are no conditions on a money movement, there is a fast path in which such a transaction is completed more quickly than if conditions existed on the money movement. For example, in some embodiments, for transactions having money movements involving money being transferred into the payment processor, these money movements are not conditioned and therefore may be completed in a faster manner.

### Propagation Phase 3: Balance Invariant Resolver

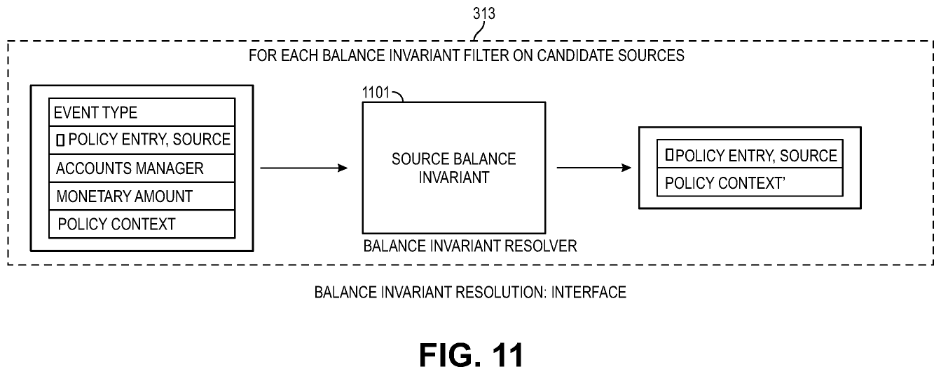

In propagation phase 3, a balance invariant resolver with a resolution interface runs relevant balance invariants on the list of source account balances for the money movements in a transaction while taking into account the current account balances. FIG. 11 illustrates one embodiment of a balance invariant resolution interface. Referring to FIG. 11, the balance invariant resolution interface, such as, for example, balance invariant resolution interface 313 of FIG. 3, includes a source balance invariant module 1101 that runs relevant balance invariants on the list of sources as part of the balance invariant resolver. The balance invariant resolver then proposes a list of source account balances and a limit as to the amount that can be drawn from each source in order to complete a money movement. In some embodiments, every balance invariant is individually deterministic. In some embodiments, examples of balance invariants include sources having sufficient funds and sources are selected based on which balance is the earliest available to fulfill a money movement.

The proposed list of source account balances, each of which is tagged, is then subject to general propagation 804. In cases where there are split entries (e.g., a money movement is split into multiple money movements to complete a transaction), those entries are feedback and run through balance invariant resolver 803 again. Subsequently, the money movement entries with their balances tagged are propagated to condition evaluation 805, which evaluates any existing conditions to determine whether the transaction can be completed as set forth or is to be rejected.

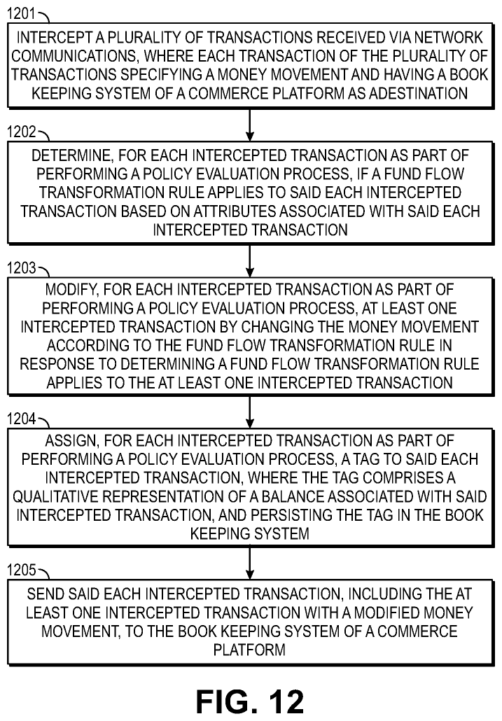

FIG. 12 is a data flow diagram of one embodiment of a process for processing money movement transactions. In some embodiments, the process is performed, at least in part, by processing logic comprising hardware (e.g., circuitry, dedicated logic, etc.), software (e.g., software running on a chip, software run on a general-purpose computer system or a dedicated machine, etc.), firmware, or a combination of the three.

Referring to FIG. 12, the process starts by processing logic intercepting a plurality of transactions received via network communications, where each transaction of the plurality of transactions specifying a money movement and having a book keeping system of a commerce platform as a destination (processing block 1201).

After intercepting transactions, processing logic determines, for each intercepted transaction as part of performing a policy evaluation process, if one or more fund flow transformation rules applies to each intercepted transaction based on attributes associated with each intercepted transaction (processing block 1202). In some embodiments, the attributes include one or more of an amount associated with the money movement of a transaction, a purpose of the money movement, a party associated with a transaction.

After determining whether a fund flow transformation rules to each intercepted transaction, processing logic modifies at least one intercepted transaction by changing the money movement according to the fund flow transformation rule (processing block 1203). In some embodiments, modifying the at least one intercepted transaction is based on an invariant. In some embodiments, modifying an intercepted transaction comprises splitting the money movement into segmented money movements, including specifying balances to be used to complete each money movement of the plurality of money movements.

In some embodiments, the policy evaluation process comprises analyzing a graph representing the money movement, and further wherein changing the money movement according to the fund flow transformation rule comprises mutating the graph based on the fund flow transformation rule. In some embodiments, after mutating the graph, processing logic determines which balances to use to complete the money movement of the at least one intercepted transaction according to the mutated graph and an ordering in which the balances are applied.

Processing logic can also assign, for each intercepted transaction as part of performing a policy evaluation process, a tag to each intercepted transaction, where the tag comprises a qualitative representation of a balance associated with said intercepted transaction, and persisting the tag in the book keeping system (processing block 1204).

Processing logic sends each intercepted transaction, including any intercepted transaction with a modified money movement, to the book keeping system of a commerce platform for completion (processing block 1205). In some embodiments, this may entail performing writes to the book keeping system.

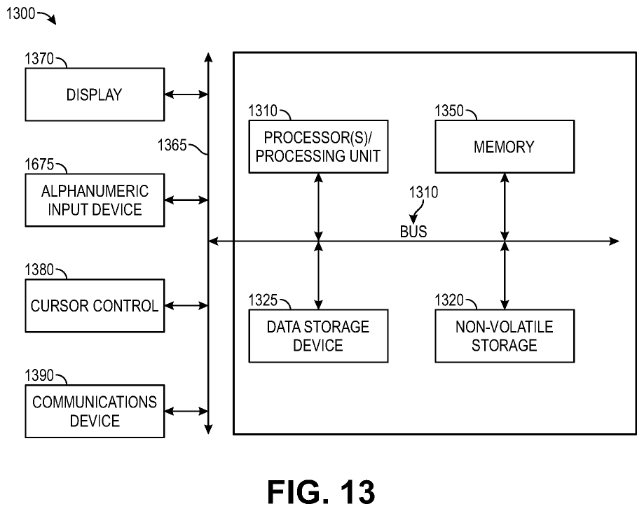

FIG. 13 is one embodiment of a computer system that may be used to support the systems and operations discussed herein. It will be apparent to those of ordinary skill in the art, however, that other alternative systems of various system architectures may also be used.

The data processing system illustrated in FIG. 13 includes a bus or other internal communication means 1315 for communicating information, and a processor(s) 1310 coupled to the bus 1315 for processing information. The system further comprises a random-access memory (RAM) or other volatile storage device 1350 (referred to as memory), coupled to bus 1315 for storing information and instructions to be executed by processor 1310. Main memory 1350 also may be used for storing temporary variables or other intermediate information during execution of instructions by processor(s) 1310. The system also comprises a read only memory (ROM) and/or static storage device 1320 coupled to bus 1315 for storing static information and instructions for processor 1310, and a data storage device 1325 such as a magnetic disk or optical disk and its corresponding disk drive. Data storage device 1325 is coupled to bus 1315 for storing information and instructions.

The system may further be coupled to a display device 1370, such as a light emitting diode (LED) display or a liquid crystal display (LCD) coupled to bus 1315 through bus 1365 for displaying information to a computer user. An alphanumeric input device 1375, including alphanumeric and other keys, may also be coupled to bus 1315 through bus 1365 for communicating information and command selections to processor 1310. An additional user input device is cursor control device 1380, such as a touchpad, mouse, a trackball, stylus, or cursor direction keys coupled to bus 1315 through bus 1365 for communicating direction information and command selections to processor 1310, and for controlling cursor movement on display device 1370.

Another device, which may optionally be coupled to computer system 1300, is a communication device 1390 for accessing other nodes of a distributed system via a network. The communication device 1390 may include any of a number of commercially available networking peripheral devices such as those used for coupling to an Ethernet, token ring, Internet, or wide area network. The communication device 1390 may further be a null-modem connection, or any other mechanism that provides connectivity between the computer system 1300 and the outside world. Note that any or all of the components of this system illustrated in FIG. 13 and associated hardware may be used in various embodiments as discussed herein.

In one embodiment, processor(s) 1310 executes instructions to perform any of the operations described above including, but not limited to, intercepting transactions received via network communications, where each transaction of the plurality of transactions specifies a money movement request and is destined for a book keeping system of a commerce platform. Other operations include, for each intercepted transaction as part of performing a policy evaluation process, determining, if a fund flow transformation rule applies to each intercepted transaction based on attributes associated with each intercepted transaction, modifying at least one intercepted transaction by changing the money movement according to the fund flow transformation rule in response to determining a fund flow transformation rule applies to the at least one intercepted transaction, and thereafter sending each intercepted transaction, including those intercepted transactions with modified money movements, to the book keeping system of a commerce platform. In some other embodiments, other operations include assigning a tag to each intercepted transaction, where the tag comprises a qualitative representation of a balance associated with the intercepted transaction, and persisting the tag in the book keeping system.

It will be appreciated by those of ordinary skill in the art that any configuration of the system may be used for various purposes according to the particular implementation. The control logic or software implementing the described embodiments can be stored in main memory 1350, mass storage device 1325, or other storage medium locally or remotely accessible to processor 1310.

It will be apparent to those of ordinary skill in the art that the system, method, and process described herein can be implemented as software stored in main memory 1350 or read only memory 1320 and executed by processor 1310. This control logic or software may also be resident on an article of manufacture comprising a computer readable medium having computer readable program code embodied therein and being readable by the mass storage device 1325 and for causing the processor 1310 to operate in accordance with the methods and teachings herein.

The embodiments discussed herein may also be embodied in a handheld or portable device containing a subset of the computer hardware components described above. For example, the handheld device may be configured to contain only the bus 1365, the processor 1310, and memory 1350 and/or 1325. The handheld device may also be configured to include a set of buttons or input signaling components with which a user may select from a set of available options. The handheld device may also be configured to include an output apparatus such as a liquid crystal display (LCD) or display element matrix for displaying information to a user of the handheld device. Conventional methods may be used to implement such a handheld device. The implementation of embodiments for such a device would be apparent to one of ordinary skill in the art given the disclosure as provided herein.

The embodiments discussed herein may also be embodied in a special purpose appliance including a subset of the computer hardware components described above. For example, the appliance may include a processor 1310, a data storage device 1325, a bus 1315, and memory 1350, and only rudimentary communications mechanisms, such as a small touch-screen that permits the user to communicate in a basic manner with the device. In general, the more special-purpose the device is, the fewer of the elements need to be present for the device to function.

There are a number of example embodiments described herein.

Example 1 is a method comprising: intercepting a plurality of transactions received via network communications, each transaction of the plurality of transactions specifying a money movement and having a book keeping system of a commerce platform as a destination; and for each intercepted transaction, performing a policy evaluation process that includes determining if a fund flow transformation rule applies to said each intercepted transaction based on attributes associated with said each intercepted transaction, modifying at least one intercepted transaction by changing the money movement according to the fund flow transformation rule in response to determining a fund flow transformation rule applies to the at least one intercepted transaction, and sending said each intercepted transaction, including the at least one intercepted transaction with a modified money movement, to the book keeping system of a commerce platform.

Example 2 is the method of example 1 that may optionally include that the attributes include one or more of an amount associated with the money movement of a transaction, a purpose of the money movement, a party associated with a transaction.

Example 3 is the method of example 1 that may optionally include that modifying the at least one intercepted transaction is based on an invariant.

Example 4 is the method of example 1 that may optionally include that modifying the at least one intercepted transaction comprises splitting the money movement into segmented money movements, including specifying balances to be used to complete each money movement of the plurality of money movements.

Example 5 is the method of example 1 that may optionally include that the policy evaluation process comprises analyzing a graph representing the money movement, and further wherein changing the money movement according to the fund flow transformation rule comprises mutating the graph based on the fund flow transformation rule.

Example 6 is the method of example 5 that may optionally include, after mutating the graph, determining which balances to use to complete the money movement of the at least one intercepted transaction according to the mutated graph and an ordering in which the balances are applied.

Example 7 is the method of example 1 that may optionally include that the policy evaluation process comprises assigning a tag to said each intercepted transaction, where the tag comprises a qualitative representation of a balance associated with said intercepted transaction, and persisting the tag in the book keeping system.

Example 8 is one or more non-transitory computer readable storage media having instructions stored thereupon which, when executed by a system having at least a processor and a memory therein, cause the system to perform operations comprising: intercepting a plurality of transactions received via network communications, each transaction of the plurality of transactions specifying a money movement and having a book keeping system of a commerce platform as a destination; and for each intercepted transaction, performing a policy evaluation process that includes determining if a fund flow transformation rule applies to said each intercepted transaction based on attributes associated with said each intercepted transaction; modifying at least one intercepted transaction by changing the money movement according to the fund flow transformation rule in response to determining a fund flow transformation rule applies to the at least one intercepted transaction; sending said each intercepted transaction, including the at least one intercepted transaction with a modified money movement, to the book keeping system of a commerce platform.

Example 9 is the one or more non-transitory computer readable storage media of example 8 that may optionally include that the attributes include one or more of an amount associated with the money movement of a transaction, a purpose of the money movement, a party associated with a transaction.

Example 10 is the one or more non-transitory computer readable storage media of example 8 that may optionally include that modifying the at least one intercepted transaction is based on an invariant.

Example 11 is the one or more non-transitory computer readable storage media of example 8 that may optionally include that modifying the at least one intercepted transaction comprises splitting the money movement into segmented money movements, including specifying balances to be used to complete each money movement of the plurality of money movements.

Example 12 is the one or more non-transitory computer readable storage media of example 8 that may optionally include that the policy evaluation process comprises analyzing a graph representing the money movement, and further wherein changing the money movement according to the fund flow transformation rule comprises mutating the graph based on the fund flow transformation rule.

Example 13 is the one or more non-transitory computer readable storage media of example 8 that may optionally include, after mutating the graph, determining which balances to use to complete the money movement of the at least one intercepted transaction according to the mutated graph and an ordering in which the balances are applied.

Example 14 is the one or more non-transitory computer readable storage media of example 8 that may optionally include that the policy evaluation process comprises assigning a tag to said each intercepted transaction, where the tag comprises a qualitative representation of a balance associated with said intercepted transaction, and persisting the tag in the book keeping system.

Example 15 is a system comprising: a memory to store instructions; and one or more processors coupled to the memory to execute the stored instructions to run a policy engine to: intercept a plurality of transactions received via network communications, each transaction of the plurality of transactions specifying a money movement and having a book keeping system of a commerce platform as a destination; and for each intercepted transaction, perform a policy evaluation process that includes determining if a fund flow transformation rule applies to said each intercepted transaction based on attributes associated with said each intercepted transaction, modifying at least one intercepted transaction by changing the money movement according to the fund flow transformation rule in response to determining a fund flow transformation rule applies to the at least one intercepted transaction, and sending said each intercepted transaction, including the at least one intercepted transaction with a modified money movement, to the book keeping system of a commerce platform.

Example 16 is the one or more non-transitory computer readable storage media of example 15 that may optionally include that the attributes include one or more of an amount associated with the money movement of a transaction, a purpose of the money movement, a party associated with a transaction.

Example 17 is the one or more non-transitory computer readable storage media of example 15 that may optionally include that modifying the at least one intercepted transaction is based on an invariant.

Example 18 is the one or more non-transitory computer readable storage media of example 15 that may optionally include that modifying the at least one intercepted transaction comprises splitting the money movement into segmented money movements, including specifying balances to be used to complete each money movement of the plurality of money movements.

Example 19 is the one or more non-transitory computer readable storage media of example 15 that may optionally include that the policy evaluation process comprises: analyzing a graph representing the money movement, and further wherein changing the money movement according to the fund flow transformation rule comprises mutating the graph based on the fund flow transformation rule; and after mutating the graph, determining which balances to use to complete the money movement of the at least one intercepted transaction according to the mutated graph and an ordering in which the balances are applied.

Example 20 is the one or more non-transitory computer readable storage media of example 15 that may optionally include that the policy evaluation process comprises assigning a tag to said each intercepted transaction, where the tag comprises a qualitative representation of a balance associated with said intercepted transaction, and persisting the tag in the book keeping system.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present disclosure is not described with reference to any particular programming language. It will be appreciated that a variety of programming languages may be used to implement the teachings of the disclosure as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

Whereas many alterations and modifications of the present disclosure will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the disclosure.

1. A method comprising:
intercepting, by an RPC handler executing on a computing device, the RPC handler comprising a gating rule evaluator and a fund flow transformer, a plurality of transactions received via network communications, each transaction of the plurality of transactions specifying a money movement and having a book keeping system of a commerce platform as a destination; and
for each intercepted transaction, performing a policy evaluation process that includes:
determining, with the gating rules evaluator, if a fund flow transformation rule applies to said each intercepted transaction based on attributes associated with said each intercepted transaction,
modifying, with the fund flow transformer, at least one intercepted transaction by changing the money movement according to the fund flow transformation rule in response to determining a fund flow transformation rule applies to the at least one intercepted transaction, and
sending, by the RPC handler, executing on the computing device, said each intercepted transaction, including the at least one intercepted transaction with a modified money movement, to the book keeping system of a commerce platform.

2. The method of claim 1 wherein the attributes include one or more of an amount associated with the money movement of a transaction, a purpose of the money movement, a party associated with a transaction.

3. The method of claim 1 wherein modifying the at least one intercepted transaction is based on an invariant.

4. The method of claim 1 wherein modifying the at least one intercepted transaction comprises:
splitting the money movement of the at least one intercepted transaction into two or more new transactions that comprise two or more segmented money movements, including specifying balances to be used to complete each money movement of the two or more new transactions; and
executing, in parallel, the two or more new transactions causing two or more segmented money movements.

5. The method of claim 1 wherein the policy evaluation process comprises analyzing a graph representing the money movement, and further wherein changing the money movement according to the fund flow transformation rule comprises mutating the graph based on the fund flow transformation rule.

6. The method of claim 5 further comprising, after mutating the graph, determining which balances to use to complete the money movement of the at least one intercepted transaction according to the mutated graph and an ordering in which the balances are applied.

7. The method of claim 1 wherein the policy evaluation process comprises assigning a tag to said each intercepted transaction, where the tag comprises a qualitative representation of a balance associated with said intercepted transaction, and persisting the tag in the book keeping system.

8. A non-transitory computer readable storage media having instructions stored thereupon which, when executed by a system having at least a processor and a memory therein, cause the system to perform operations comprising:
intercepting, by an RPC handler executing on a computing device, the RPC handler comprising a gating rule evaluator and a fund flow transformer, a plurality of transactions received via network communications, each transaction of the plurality of transactions specifying a money movement and having a book keeping system of a commerce platform as a destination; and
for each intercepted transaction, performing a policy evaluation process that includes:
determining, with the gating rules evaluator, if a fund flow transformation rule applies to said each intercepted transaction based on attributes associated with said each intercepted transaction;
modifying, with the fund flow transformer, at least one intercepted transaction by changing the money movement according to the fund flow transformation rule in response to determining a fund flow transformation rule applies to the at least one intercepted transaction; and
sending, by the RPC handler, executing on the computing device, said each intercepted transaction, including the at least one intercepted transaction with a modified money movement, to the book keeping system of a commerce platform.

9. The one or more non-transitory computer readable storage media of claim 8 wherein the attributes include one or more of an amount associated with the money movement of a transaction, a purpose of the money movement, a party associated with a transaction.

10. The one or more non-transitory computer readable storage media of claim 8 wherein modifying the at least one intercepted transaction is based on an invariant.

11. The one or more non-transitory computer readable storage media of claim 8 wherein modifying the at least one intercepted transaction comprises:
splitting the money movement into segmented money movements, including specifying balances to be used to complete each money movement of the two or more new transactions; and
executing, in parallel, the two or more new transactions causing the two or more segmented money movements.

12. The one or more non-transitory computer readable storage media of claim 8 wherein the policy evaluation process comprises analyzing a graph representing the money movement, and further wherein changing the money movement according to the fund flow transformation rule comprises mutating the graph based on the fund flow transformation rule.

13. The one or more non-transitory computer readable storage media of claim 12 further comprising, after mutating the graph, determining which balances to use to complete the money movement of the at least one intercepted transaction according to the mutated graph and an ordering in which the balances are applied.

14. The one or more non-transitory computer readable storage media of claim 8 wherein the policy evaluation process comprises assigning a tag to said each intercepted transaction, where the tag comprises a qualitative representation of a balance associated with said intercepted transaction, and persisting the tag in the book keeping system.

15. A system comprising:
a memory to store instructions; and
one or more processors coupled to the memory to execute the stored instructions to run a policy engine to:
intercept, by an RPC handler executing on a computing device, the RPC handler comprising a gating rule evaluator and a fund flow transformer, a plurality of transactions received via network communications, each transaction of the plurality of transactions specifying a money movement and having a book keeping system of a commerce platform as a destination; and
for each intercepted transaction, perform a policy evaluation process that includes:
determining, with the gating rules evaluator, if a fund flow transformation rule applies to said each intercepted transaction based on attributes associated with said each intercepted transaction;
modifying, with the fund flow transformer, at least one intercepted transaction by changing the money movement according to the fund flow transformation rule in response to determining a fund flow transformation rule applies to the at least one intercepted transaction; and
sending said each intercepted transaction, including the at least one intercepted transaction with a modified money movement, to the book keeping system of a commerce platform.

16. The system of claim 15 wherein the attributes include one or more of an amount associated with the money movement of a transaction, a purpose of the money movement, a party associated with a transaction.

17. The system of claim 15 wherein modifying the at least one intercepted transaction is based on an invariant.

18. The system of claim 15 wherein modifying the at least one intercepted transaction comprises:
splitting the money movement into segmented money movements, including specifying balances to be used to complete each money movement of the two or more new transactions; and
executing, in parallel, the two or more new transactions causing the two or more segmented money movements.

19. The system of claim 15 wherein the policy evaluation process comprises:
analyzing a graph representing the money movement, and further wherein changing the money movement according to the fund flow transformation rule comprises mutating the graph based on the fund flow transformation rule; and
after mutating the graph, determining which balances to use to complete the money movement of the at least one intercepted transaction according to the mutated graph and an ordering in which the balances are applied.

20. The system of claim 15 wherein the policy evaluation process comprises assigning a tag to said each intercepted transaction, where the tag comprises a qualitative representation of a balance associated with said intercepted transaction, and persisting the tag in the book keeping system.
